(19) United States
(12) Patent Application Publication
(10) Pub. No.: US 2003/0040301 A1
(43) Pub. Date: Feb. 27, 2003

(54) Voice data transmission method, communication system and communication terminal

(76) Inventor: Atsushi Fukuzato, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/223,463

(22) Filed: Aug. 20, 2002

(30) Foreign Application Priority Data
Aug. 21, 2001 (JP) 249891/2001

(51) Int. Cl. H04M 11/10; H04B 7/00; H04Q 7/20

(52) U.S. Cl. 455/412; 455/413; 455/517

(57) ABSTRACT

A transmitting side terminal records voice data, and transmits the recorded voice data together with a control signal for controlling the operation of the receiving side terminal. The receiving side terminal does storage and reproduction of the voice data on the basis of the received control signal.

### BACKGROUND OF THE INVENTION

This application claims benefit of Japanese Patent Application No. 2001-249891 filed on Aug. 21, 2001, the contents of which are incorporated by the reference.

The present invention relates to message communication between communication terminals and, more particularly, to message communication between mobile communication terminals.

Up to date, message communication mainly of such letter data as mails and short mails by utilizing such mobile communication terminals as portable telephone terminals and PHSs (personal handy phone system) terminals has been popular.

In this type of message communication, it is readily possible to simply inform the sole business. Also, the message to be transmitted can be sufficiently polished before transmission to the opposite side. Furthermore, since the message is stored in the opposite side terminal, the receiver can repeatedly read out the message.

Messages such as above are usually inputted to communication terminal by using such an input unit as a keyboard. This inputting operation, however, can not be easy for anybody. Particularly, in a mobile communication terminal the difficulty of the inputting operation is increased because all alphabet letters are inputted with ten and several keys.

Meanwhile, as message transfer other than that of mainly text messages, one utilizing message telephone is conceivable. In the case of utilizing the message telephone, the message content can be inputted by merely speaking it to the transmitting side communication terminal, requiring a few key operations for storing and editing the inputted message.

However, the message transfer by message telephone has the following problems. First, for polishing a message, it is necessary to continuously hold connection to a message telephone center or the opposite side terminal. The polish operation is repetition of recording and reproduction, a voice to be finally transmitted to the opposite side terminal is the sole finally recorded voice. In the message transmission to message telephone, however, unnecessary voice which is generated during the polish operation should also be transmitted. As a second problem, a message transmitter, who desires only leaving a message and does not desire any talk, cannot select this. This is so because it is on the receiver side to determine whether or not the a message telephone function is to be made operative.

### SUMMARY OF THE INVENTION

The present invention was made in view of the foregoing circumstance, and it seeks to solve problems inherent in the prior art by the provision of voice data transmission method, communication system and communication terminal, which permits message input by a simple operation, does not necessitate connection to opposite side communication terminal or the like and is capable of simply transmit sole message to the opposite side.

According to an aspect of the present invention, there is provided a method of transmitting voice data from a first communication terminal to a second communication terminal, comprising: a first step of recording voice data in the first communication terminal; a second step of generating data A including voice data recorded in the first communication terminal and a control signal for controlling the operation of the second communication terminal; a third step of transmitting the data A from the first communication terminal to the second communication terminal; and a fourth step, in which the second communication terminal stores voice data contained in the data A and reproduces the voice data on the basis of the control signal contained in the received data A.

The first and second communication terminals are both mobile communication terminals. In the fourth step the second communication terminal starts the voice data reproduction after completion of the voice data storage. In the fourth step the second communication terminal reproduces the voice data concurrently with the voice data storage.

According to another aspect of the present invention, there is provided a communication system for transmitting voice data from a first communication terminal to a second communication terminal, wherein: the first communication terminal includes: a first means for recording voice data; a second means for generating data A including the recorded voice data and a control signal for controlling the operation of the second communication terminal; and a third means for transmitting the data A to the second communication terminal; and the second communication terminal includes: a fourth means for receiving the data A form the first communication terminal; a fifth means for storing voice data contained in the received data A on the basis of the control signal contained therein; and a sixth means for reproducing the voice data contained in the data A according to a control signal contained therein.

The first and second communication terminals are both mobile communication terminals. The sixth means reproduces the voice data stored in the fifth means. In the sixth means reproduces the voice data concurrently with the voice data storage in the fifth means.

According to other aspect of the present invention, there is provided a communication terminal comprising: a first means for recording voice data; a second means for generating data A containing the recorded voice data and a control signal commanding the storage and reproduction of the voice data with respect to other communication terminals; and a third means for transmitting the data A to the other communication terminals.

According to still other aspect of the present invention, there is provided a communication terminal comprising: a fourth means for receiving data A including recorded voice data and a control signal for controlling the operation of the communication terminal from the other communication terminals; a fifth means for storing the voice data contained in the data A on the basis of the control signal contained therein; and a sixth means for reproducing the voice data contained in the data A on the basis of the control signal contained therein.

The sixth means reproduces the voice data stored in the fifth means. The fifth means reproduces the voice data concurrently with the voice data storage in the fifth means. The communication terminal is a mobile communication terminal.

According to further aspect of the present invention, there is provided a communication system for transmitting voice data from a first communication terminal to a second communication terminal, wherein the first communication terminal performs the following steps of: a first step for storing an input voice data in a first memory in an voice data input mode settable by a user's operation; a second step for selecting a usual communication mode or a voice data transmission mode; and a third step for performing the usual communication when the usual communication mode is selected and transmitting the voice data and a specified data indicating the selection of the voice data transmission mode, and then disconnecting a line.

The first communication terminal further performs a fourth step for checking whether the voice data have been completely transmitted, and re-transmitting the voice data after re-connecting the line when the voice data have not been completely transmitted. The first communication terminal further performs a fifth step for ending the voice data transmission when the communication zone is not covered or when the second communication terminal is rejecting the call reception.

According to still further aspect of the present invention, there is provided a communication system for transmitting voice data from a first communication terminal to a second communication terminal, wherein the first communication terminal performs the following steps of: a first step for storing an input voice data in a first memory in an voice data input mode settable by a user's operation; a second step for selecting a usual communication mode or a voice data transmission mode; and a third step for performing the usual communication when the usual communication mode is selected and transmitting the voice data and a specified data indicating the selection of the voice data transmission mode, and then disconnecting a line, and the second communication terminal performs the following steps of: a sixth step for storing the received voice data in a second memory when the voice data transmission mode selection is judged on the basis of the specified data and reproducing a voice based on the stored received voice data.

According to still more aspect of the present invention, there is provided a communication system for transmitting voice data from a first communication terminal to a second communication terminal, wherein the first communication terminal performs the following steps of: a first step for storing an input voice data in a first memory in an voice data input mode settable by a user's operation; a second step for selecting a usual communication mode or a voice data transmission mode; and a third step for performing the usual communication when the usual communication mode is selected and transmitting the voice data and a specified data indicating the selection of the voice data transmission mode, and then disconnecting a line, and the second communication terminal performs the following steps of: a sixth step for storing the received voice data in a second memory when the voice data transmission mode selection is judged on the basis of the specified data and reproducing a voice based on the stored received voice data; and a seventh step for disconnecting the line when the voice data reception and storage is completed.

Other objects and features will be clarified from the following description with reference to attached drawings.

### BRIEF DESCRIPTION OF THE DRAWINGS

FIG. 1 shows basic system of a mobile communication system according to a first embodiment of the present invention;

FIG. 2 shows a hardware construction of a mobile communication terminal 5 in the mobile communication system 1 shown in FIG. 1;

FIG. 3 shows a software structure on the mobile communication terminal 5;

FIG. 4 shows a flowchart for explaining the recording operation of the voice message by the transmitting side terminal 2;

FIG. 5 shows a flow chart for explaining the recording operation of transmission of the voice message from the transmitting side terminal 2 to the receiving side terminal 4;

FIG. 6 shows the format of the transmission data 20 used for transmission of the voice message from the transmitting side terminal 2 to the receiving side terminal 4;

FIG. 7 shows a flow chart for explaining the operation of the receiving side terminal 4 according to the first embodiment;

FIG. 8 shows a flow chart for explaining the operation of the receiving side terminal 4 according to the second embodiment; and

FIG. 9 shows a flow chart for explaining the operation of the receiving side terminal 4 according to the second embodiment.

### PREFERRED EMBODIMENTS OF THE INVENTION

Preferred embodiments of the present invention will now be described with reference to the drawings.

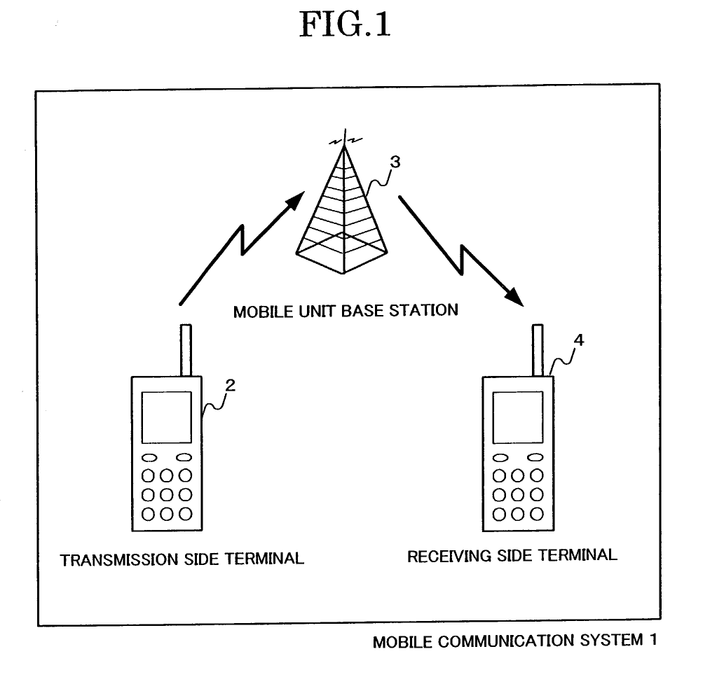

A mobile communication system 1 as a first embodiment of the present invention will now be described with reference to FIG. 1. The mobile communication system 1 comprises a transmitting side terminal 2, a mobile unit base station 3 and a receiving side terminal 4. The transmitting side terminal 2 is a mobile communication terminal utilized by a voice message transmitter (person). A message voicely inputted by the transmitter is recorded in the inside of the transmitting side terminal 2, and is transmitted via the mobile unit base station 3 to the receiving side terminal 4. The mobile unit base station 3 is a relay point between the transmitting and receiving side terminals 2 and 4, and it relays voice message received from the transmitting side terminal 2 for transmission to the receiving side terminal 4. The receiving side terminal 4 is a mobile communication terminal utilized by the voice message receiver, and it analyzes the message received from the transmitting side terminal 2.

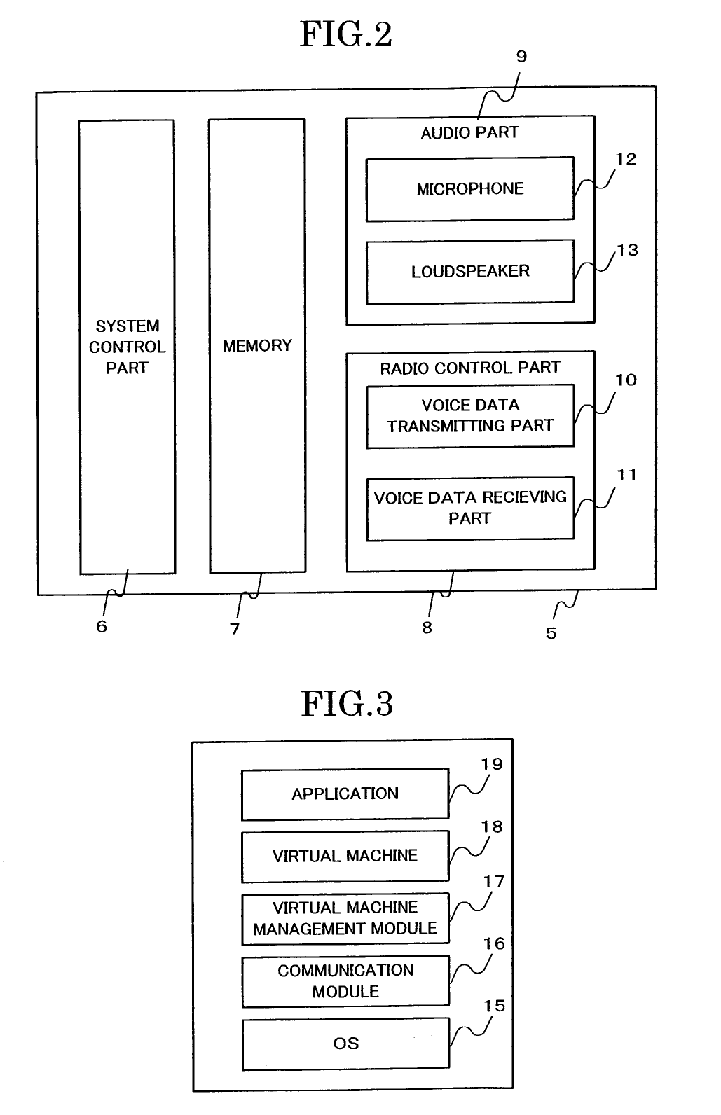

The hardware construction of a mobile communication terminal 5 capable of functioning both the transmitting and receiving side terminals 2 and 4 will now be described with reference to FIG. 2. The mobile communication terminal 5 comprises a system control part 6, a memory 7, a radio control part 8 and an audio part 9. The system control part 6 controls the operation of the mobile communication terminal 5. The memory 7 functions such that when the mobile communication terminal 5 functions as the transmitting side terminal 2, it stores a voice message to be transmitted, while when the mobile communication terminal 5 functions as the receiving side terminal 4, it stores the received voice message. The radio control part 8 includes a voice data transmitting part 10 and a voice data receiving part 11. The voice data transmitting part 10 performs a transmitting process of voice data. The voice data receiving part 11 performs a receiving process of voice message. The audio part 9 includes a microphone 12 and a loudspeaker 13. The microphone 12 is a unit for inputting a voice message to be transmitted. The loudspeaker 13 outputs the inputted voice message as actual voice.

Software which operates on the mobile communication terminal 5 will now be described with reference to FIG. 3. This has a hierarchical structure having an OS 15, a communication module 16, a virtual machine management module 17, a virtual machine 18 and an application 19, these elements being provided as successive layers in the mentioned order from the lowermost layer. The communication module 16 transmits and receives the voice communication data. The virtual machine management module 17 manages the operation of the virtual machine 18. The virtual machine 18 is a virtual computer predetermined independently from the specifications of the system control part 6. The application 19 is an application produced for the virtual machine 18, and it operates on the virtual machine 18. The virtual machine management module 17 controls the operation of the application 19 on the mobile communication terminal 5 according to the virtual machine 18. The virtual machine management module 17, the virtual machine 18 and the application 19 are realized by using a JAVA (a trademark), for instance. In this embodiment, the main function of the present invention is actually provided as the application 19. The application 19 is an all-time application, and it constitutes a module for monitoring the communication function of the mobile communication terminal 5. The OS 15 represents a platform, and it may be of any kind because the main operation according to the present invention is actually provided as the application 19 operating on the virtual machine 18.

The operation of the mobile communication system 1 until voice message inputted in the transmitting side terminal 2 is reproduced in the receiving side terminal 4.

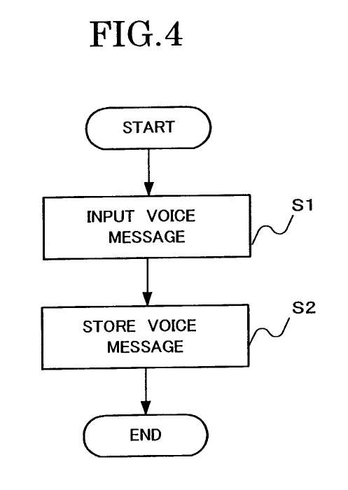

In the first place, the inputting of voice message in the movable communication terminal 5 which operates as the transmitting side terminal 2 will be described with reference to FIG. 4. When the user of the mobile communication terminal 5 operating as the transmitting side terminal 2 (hereinafter referred to as transmitter) performs a predetermined operation with respect to the mobile communication terminal 5, the movable communication terminal 5 is brought to a voice message input mode. When the transmitter vocally inputs a message to be transmitted by using the microphone 12 (step S1), the movable communication terminal 5 stores the voice message in the memory 7 (step S2).

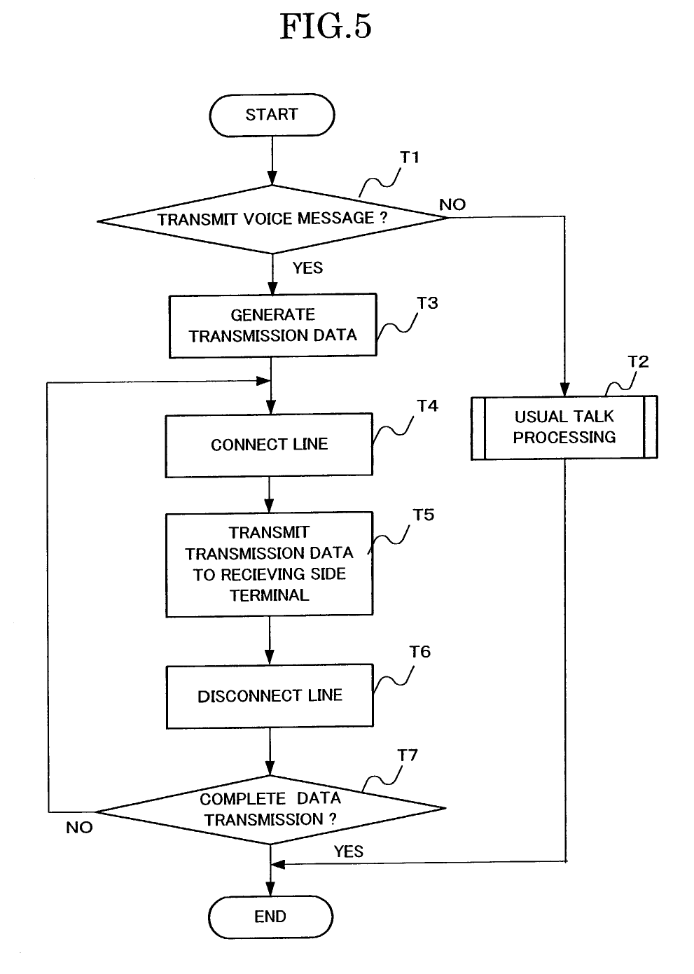

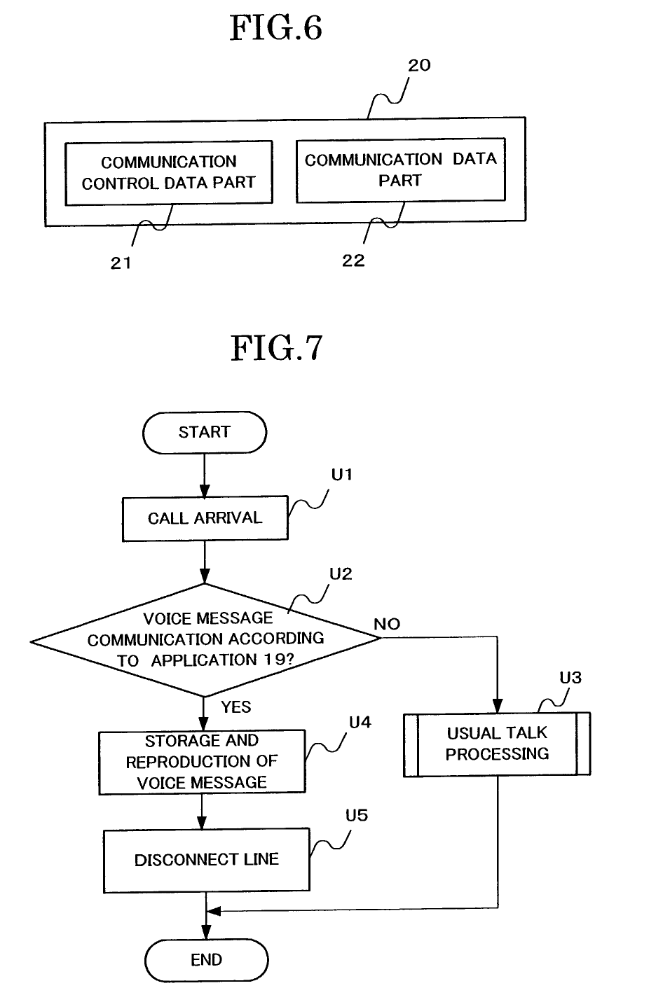

The voice message stored in this way is transmitted to the receiving side terminal 4 as shown in FIG. 5. First, either transmission of the recorded voice message or normal talk is selected according to the transmitter's operation (step T1). When the normal talk is selected, conventional usual talk between the telephone terminals is permitted (step T2). This operation is not described in detail. When the voice message transmission is selected, the transmission data 20 of the format as shown in FIG. 6 is generated from the voice message which has been stored in the manner as shown in FIG. 4 (step T3). As for the transmission data 20, the communication control data part 21 is a bit group provided for checking the kind of the transmission data 20 in each layer at the time of transmission of the transmission data 20. This bit group includes an expansion bit indicative of the voice message communication based on the application 19 according to the present invention. In the communication data part 22, a voice message to be transmitted is stored. Then, a line is connected to the receiving side terminal 4 of the telephone number designated by the transmitter (step T4), then the transmission data 20 is transmitted to the receiving side terminal 4 (step T5), and then the line is automatically disconnected (step T6). Then, a check is made as to whether the voice message could have been completely transmitted (step T7). In the event of failure of complete transmission of the voice message due to such case as communication interference, the sequence operation goes back to the step T4 of the line connection to repeat the preceding process. With this repetitive process, the transmitter can check whether the voice message has been normally transmitted. In the case when the communication zone is not covered or when the receiving side terminal 4 is rejecting the call reception in the stage of the step T4, an end is brought to the sequence operation without process repetition.

The operation of the mobile communication terminal 5 as the receiving side terminal 4 will now be described with reference to FIG. 7. When a call from the transmitting side terminal 2 arrives (step U1), the mobile communication terminal 5 makes a check, with reference to the expansion bit contained in the communication control data part 21, as to whether the call is of the voice message communication in the application 19 according to the present invention (U2). When the call is not of voice message communication, the conventional usual communication between the telephone terminals is permitted (step U3), and this operation is not described in detail. When this check can not be made because of the absence of the expansion bit, the process is continued as usual communication. Thus, versatility with terminals not pertinent to the present invention can be held. In the case of voice message communication, the system control part 6 stores the communication data part 22 extracted from the transmission data 20, i.e., the voice message, in the memory 7, while reproducing the voice message for output from the loudspeaker 13 (step U4). When the storage and reproduction of the voice message have been ended, the line is disconnected (step U5).

A second embodiment of the present invention will now be described. The second embodiment is different from the first embodiment in the constitution of the application 19 and the operation of the receiving side terminal 4. In the first embodiment, the application 19 has been constituted by an all-time application. On the other hand, in the second embodiment the application 19 is constituted by an all-time application (hereinafter referred to as application 191) and a non-all-time application (hereinafter referred to as application 192).

With data transfer rate increase and data compression efficiency improvement, it is conceivable that the reception and storage of voice message are ended before the end of the voice message reproduction. In the first embodiment, however, the line is disconnected after the storage and reproduction of voice message have both been ended. This means that the line continues to be connected even after the end of the voice message reception. On the other hand, in the second embodiment, as soon as the reception and storage of voice message have been ended, the line is disconnected even while the voice message reproduction is still in force.

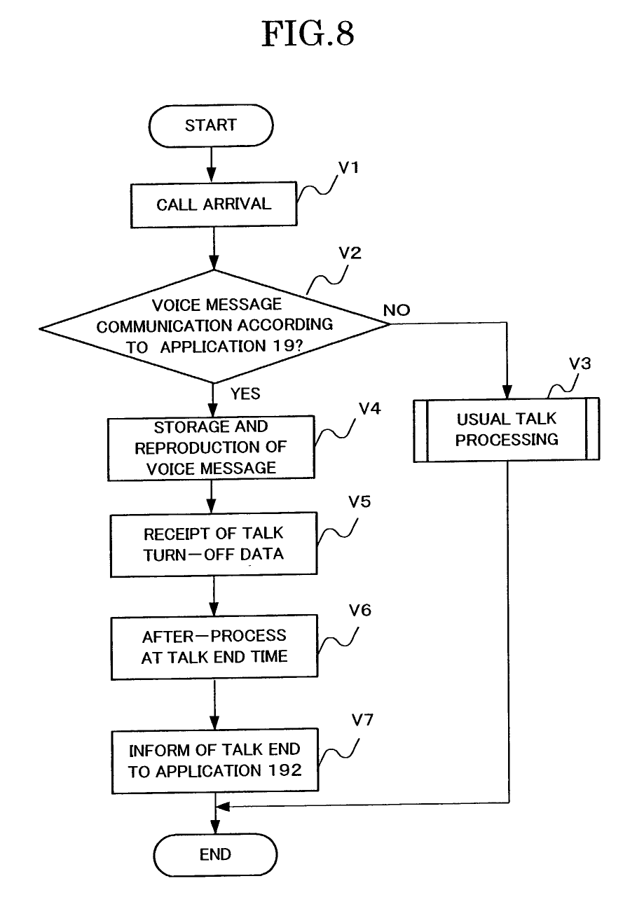

The operation of the mobile communication terminal 5 in the application 191 will now be described with reference to FIG. 8. When a call arrives (step V1), the mobile communication terminal 5 makes a check, with reference to the expansion bit contained in the communication control data part 21, as to whether the call is of voice message communication in the application 19 according to the present invention (step V2). When the call is not of voice message communication, the conventional usual communication between the telephone terminals is permitted (step V3), and this operation is not described in detail. When the call is of the voice message communication, the mobile communication terminal 5 starts a process of storing the voice message in the memory 7 and also a process of reproducing the voice message for output thereof from the loudspeaker 13 (step V4). When the mobile communication terminal 5 subsequently receives a talk turn-off data from the transmitting side terminal 2 (step V5), it executes an after-process at the talk end time (step V6), and informs the application 192 of the talk end (step V7), while also informing the user of the mobile communication terminal 5 working as the receiving side terminal 4 (hereinafter referred to as receiver) of the talk end.

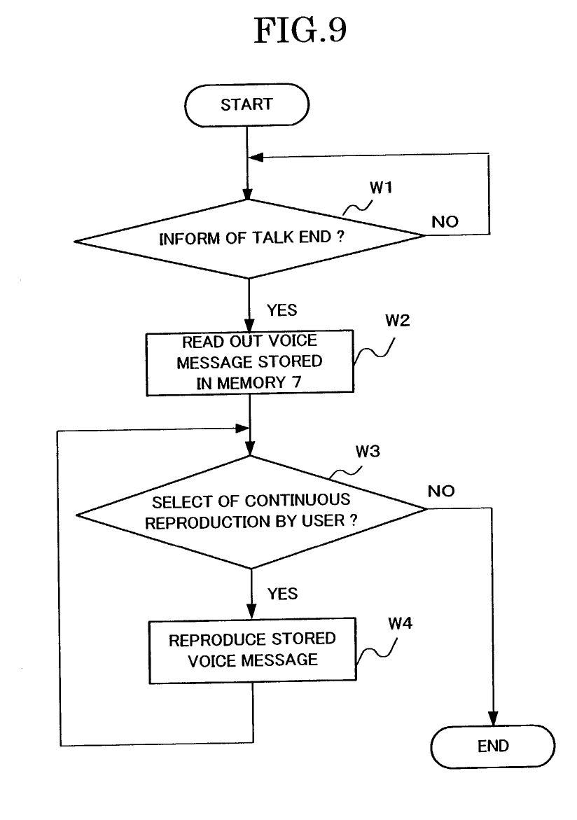

The operation of the application 192 which has received information in the step V7 will now be described with reference to FIG. 9. When the talk end is informed in the application 191 (step W1), access to the memory 7 is made to read out data pertinent to the voice message reproduced so far (step W2). At this time, confirmation to the receiver is made as to whether continuous voice message reproduction is made with respect to the user of the mobile communication terminal 5 (step W3). When the reproduction is instructed, the corresponding data is recorded (step W4).

While the present invention has been described with respect to the preferred embodiments thereof, these embodiments are by no means limitative, and changes and improvements can of course be made without departing from the scope of the ordinary knowledge of the person in the art.

For example, in the above embodiments the main functions of the present invention have been provided as the application of software as shown in FIG. 3, it is obvious to the person in the art that these functions may be provided as hardware as well.

According to the present invention, the message input can be readily made since it is performed as voice input operation. In addition, the message editing operation can be completed by the sole transmitting side terminal, and during the editing operation it is not necessary to make connection to the receiving side terminal or a so-called telephone message center. Furthermore, storage and reproduction of voice are requested with control signal to the receiving side terminal. Thus, it is possible to simply transmit message to the opposite side.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A method of transmitting voice data from a first communication terminal to a second communication terminal, comprising:
a first step of recording voice data in the first communication terminal;
a second step of generating data A including voice data recorded in the first communication terminal and a control signal for controlling the operation of the second communication terminal;
a third step of transmitting the data A from the first communication terminal to the second communication terminal; and
a fourth step, in which the second communication terminal stores voice data contained in the data A and reproduces the voice data on the basis of the control signal contained in the received data A.

2. The method of transmitting voice data according to claim 1, wherein the first and second communication terminals are both mobile communication terminals.

3. The method of transmitting voice data according to one of claims 1 and 2, wherein in the fourth step the second communication terminal starts the voice data reproduction after completion of the voice data storage.

4. The method of transmitting voice data according to one of claims 1 and 2, wherein in the fourth step the second communication terminal reproduces the voice data concurrently with the voice data storage.

5. A communication system for transmitting voice data from a first communication terminal to a second communication terminal, wherein
the first communication terminal includes:
a first means for recording voice data;
a second means for generating data A including the recorded voice data and a control signal for controlling the operation of the second communication terminal; and
a third means for transmitting the data A to the second communication terminal; and
the second communication terminal includes:
a fourth means for receiving the data A form the first communication terminal;
a fifth means for storing voice data contained in the received data A on the basis of the control signal contained therein; and
a sixth means for reproducing the voice data contained in the data A according to a control signal contained therein.

6. The communication system according to claim 5, wherein the first and second communication terminals are both mobile communication terminals.

7. The communication system according to one of claims 5 and 6, wherein the sixth means reproduces the voice data stored in the fifth means.

8. The communication system according to one of claims 5 and 6, wherein the sixth means reproduces the voice data concurrently with the voice data storage in the fifth means.

9. A communication terminal comprising:
a first means for recording voice data;
a second means for generating data A containing the recorded voice data and a control signal commanding the storage and reproduction of the voice data with respect to other communication terminals; and
a third means for transmitting the data A to the other communication terminals.

10. A communication terminal comprising:
a fourth means for receiving data A including recorded voice data and a control signal for controlling the operation of the communication terminal from the other communication terminals;
a fifth means for storing the voice data contained in the data A on the basis of the control signal contained therein; and
a sixth means for reproducing the voice data contained in the data A on the basis of the control signal contained therein.

11. The communication terminal according to claim 10, wherein the sixth means reproduces the voice data stored in the fifth means.

12. The communication terminal according to claim 10, wherein the fifth means reproduces the voice data concurrently with the voice data storage in the fifth means.

13. The communication terminal according to one of claims 9 to 12, which is a mobile communication terminal.

14. A communication system for transmitting voice data from a first communication terminal to a second communication terminal, wherein
the first communication terminal performs the following steps of:
a first step for storing an input voice data in a first memory in an voice data input mode settable by a user's operation;
a second step for selecting a usual communication mode or a voice data transmission mode; and
a third step for performing the usual communication when the usual communication mode is selected and transmitting the voice data and a specified data indicating the selection of the voice data transmission mode, and then disconnecting a line.

15. The communication system according to claim 14, wherein the first communication terminal further performs a fourth step for checking whether the voice data have been completely transmitted, and re-transmitting the voice data after re-connecting the line when the voice data have not been completely transmitted.

16. The communication system according to claim 14, wherein the first communication terminal further performs a fifth step for ending the voice data transmission when the communication zone is not covered or when the second communication terminal is rejecting the call reception.

17. A communication system for transmitting voice data from a first communication terminal to a second communication terminal, wherein
the first communication terminal performs the following steps of:
a first step for storing an input voice data in a first memory in an voice data input mode settable by a user's operation;
a second step for selecting a usual communication mode or a voice data transmission mode; and
a third step for performing the usual communication when the usual communication mode is selected and transmitting the voice data and a specified data indicating the selection of the voice data transmission mode, and then disconnecting a line, and
the second communication terminal performs the following steps of:
a sixth step for storing the received voice data in a second memory when the voice data transmission mode selection is judged on the basis of the specified data and reproducing a voice based on the stored received voice data.

18. A communication system for transmitting voice data from a first communication terminal to a second communication terminal, wherein
the first communication terminal performs the following steps of:
a first step for storing an input voice data in a first memory in an voice data input mode settable by a user's operation;
a second step for selecting a usual communication mode or a voice data transmission mode; and
a third step for performing the usual communication when the usual communication mode is selected and transmitting the voice data and a specified data indicating the selection of the voice data transmission mode, and then disconnecting a line, and
the second communication terminal performs the following steps of:
a sixth step for storing the received voice data in a second memory when the voice data transmission mode selection is judged on the basis of the specified data and reproducing a voice based on the stored received voice data; and
a seventh step for disconnecting the line when the voice data reception and storage is completed.
